(19) United States
(12) Patent Application Publication
(10) Pub. No.: US 2020/0328977 A1
(43) Pub. Date: Oct. 15, 2020

(54) REACTIVE APPROACH TO RESOURCE ALLOCATION FOR MICRO-SERVICES BASED INFRASTRUCTURE

(71) Applicant: Cisco Technology, Inc., San Jose, CA (US)

(72) Inventors: Pierre Pfister, Angers (FR); Yoann Desmouceaux, Paris (FR); William Mark Townsley, Paris (FR)

(21) Appl. No.: 16/380,401

(22) Filed: Apr. 10, 2019

(51) Int. Cl. H04L 12/803; H04L 12/26; H04L 29/06; H04L 29/08; H04L 12/24

(52) U.S. Cl. CPC H04L 47/125; H04L 43/12; H04L 41/5041; H04L 67/2847; H04L 41/0806; H04L 69/164

(57) ABSTRACT

Systems, methods, and computer-readable media are provided for predictive content pre-fetching and allocation of resources for providing network service access. In some examples, traffic in a network environment is monitored and a related network service to a requested network service is recognized. A UDP probe for the related network service is sent to at least one candidate server of a plurality of candidate servers within the network environment. A candidate server of the plurality of candidate servers is selected for provisioning of the related network service. The candidate server gathers one or more pre-fetched resources for provisioning the related network service. Accordingly, traffic associated with provisioning of the related network service can be steered to the candidate server by a load balancer for provisioning of the related network service using the one or more pre-fetched resources.

### TECHNICAL FIELD

The present technology pertains to predictive content pre-fetching of resources for providing network service access, and in particular to assigning a candidate server of a plurality of candidate servers to provide network service access using a User Datagram Protocol (UDP) probe and pre-fetching resources to provide the network service access through the candidate server.

### BACKGROUND

Network-based services (e.g. databases, web apps, APIs, . . . ) tend to function in a reactive fashion. Load-balancers dispatch connections to different servers with a variable level of awareness of the servers load, and the servers then perform best effort to accommodate clients. In particular, in micro-services-based architectures, an initial query generally results in a large number of back-end connections, which are each load-balanced and served by application servers in a very reactive fashion. This approach may cause additional latency due to servers already being loaded at the time they receive a request, while other servers might have available resources. There therefore exist needs for systems and methods of load balancing and reducing latency in network service provisioning.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example cloud computing architecture;

FIG. 1B illustrates an example fog computing architecture;

FIG. 2A illustrates a diagram of an example network environment, such as a data center;

FIG. 2B illustrates another example of a network environment;

FIG. 3 shows an example network environment for performing load balancing and pre-fetching for network services provided through the network environment;

FIG. 4 shows an example network environment for performing load balancing and pre-fetching for predicted network services provided through the network environment;

FIG. 5 illustrates a flowchart for an example method of load balancing and pre-fetching data for provisioning a network service related to a requested network service;

FIG. 6 illustrates an example computing system; and

FIG. 7 illustrates an example network device.

### DESCRIPTION OF EXAMPLE EMBODIMENTS

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### Overview

A method can include monitoring traffic in a network environment for providing access to network services through the network environment. The method can also include identifying a related network service associated with a requested network service by monitoring the traffic in the network environment. Additionally, the method can include sending a UDP probe for the related network service within the network environment to at least one candidate server of a plurality of candidate servers for provisioning the related network service. Further, the method can include assigning a candidate server of the plurality of candidate servers to provision the related network service in response to the candidate server accepting provisioning of the related network service based on the UDP probe. The candidate server can be configured to gather one or more pre-fetched resources for provisioning the related network service. Accordingly, traffic associated with provisioning of the related network service can be steered from a load balancer to the candidate server for provisioning of the related network service using the one or more pre-fetched resources.

A system can include one or more processors and at least one computer-readable storage medium storing instructions which, when executed by the one or more processors, cause the one or more processors to monitor network traffic in a network environment for providing access to network services through the network environment. The instructions can also cause the one or more processors to identify a related network service associated with a requested network service by monitoring the traffic in the network environment. Further, the instructions can cause the one or more processors to send a UDP probe for the related network service within the network environment to at least one candidate server of a plurality of candidate servers for provisioning the related network service. Additionally, the instructions can cause the one or more processors to assign a candidate server of the plurality of candidate servers to provision the related network service in response to the candidate server accepting provisioning of the related network service based on the UDP probe. As follows, the instructions can cause the one or more processors to steer, from a load balancer of the network environment, traffic associated with provisioning of the related network service to the candidate server for provisioning of the related network service.

A non-transitory computer-readable storage medium having stored therein instructions which, when executed by a processor, cause the processor to monitor network traffic in a network environment for providing access to network services through the network environment. The instructions can cause the processor to identify a related network service associated with a requested network service by monitoring the traffic in the network environment. Further, the instructions can cause the processor to send a UDP probe for the related network service within the network environment to at least one candidate server of a plurality of candidate servers for provisioning the related network service. The UDP probe can include an SRv6 header identifying the plurality of candidate servers. The instructions can also cause the processor to assign a candidate server of the plurality of candidate servers to provision the related network service in response to the candidate server accepting provisioning of the related network service based on the UDP probe. The candidate server can be configured to gather one or more pre-fetched resources for provisioning the related network service. As follows, the instructions can cause the processor to steer, from a load balancer of the network environment, traffic associated with provisioning of the related network service to the candidate server for provisioning of the related network service.

### EXAMPLE EMBODIMENTS

The disclosed technology addresses the need in the art for both improved load balancing in network service provisioning through network environments and reducing latency in network service provisioning in network environments. The present technology involves system, methods, and computer-readable media for performing predictive content pre-fetching of resources for providing network service access. Additionally, the present technology involves systems, methods, and computer-readable media for assigning a candidate server of a plurality of candidate servers to provide network service access using a User Datagram Protocol (UDP) probe and pre-fetching resources to provide the network service access through the candidate server.

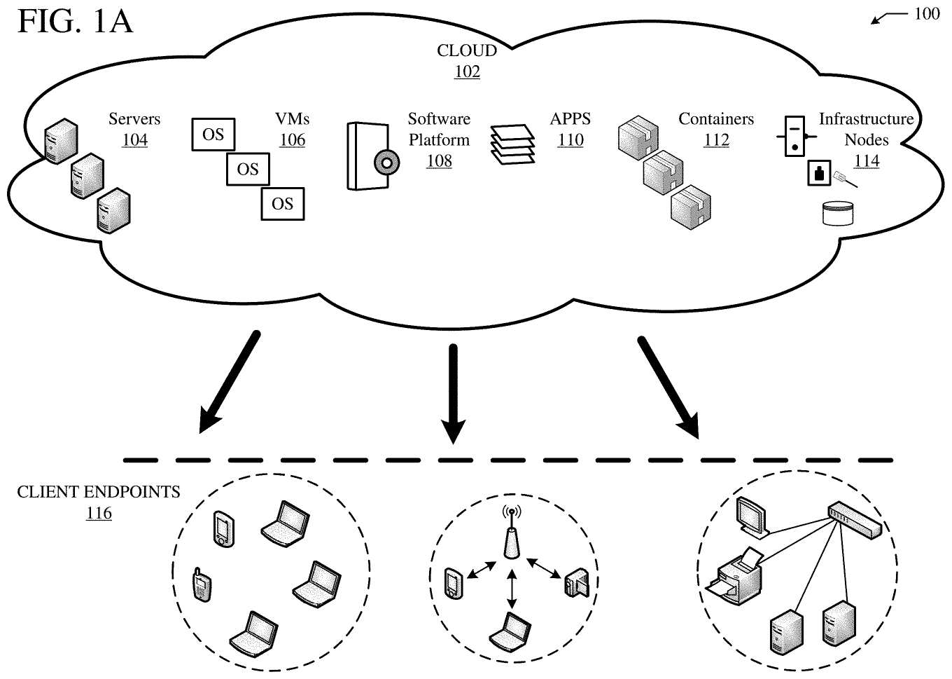

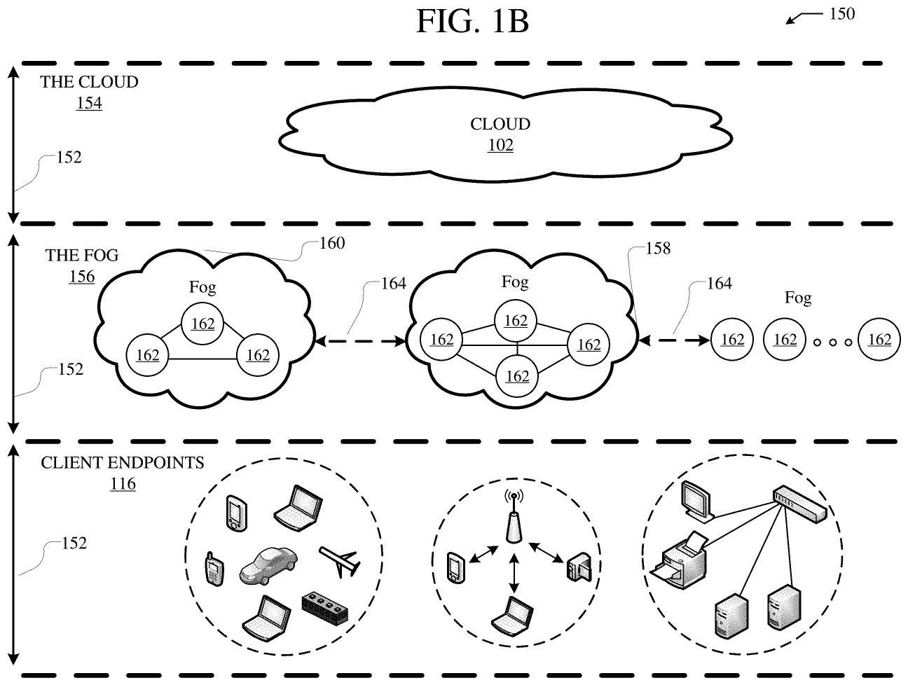

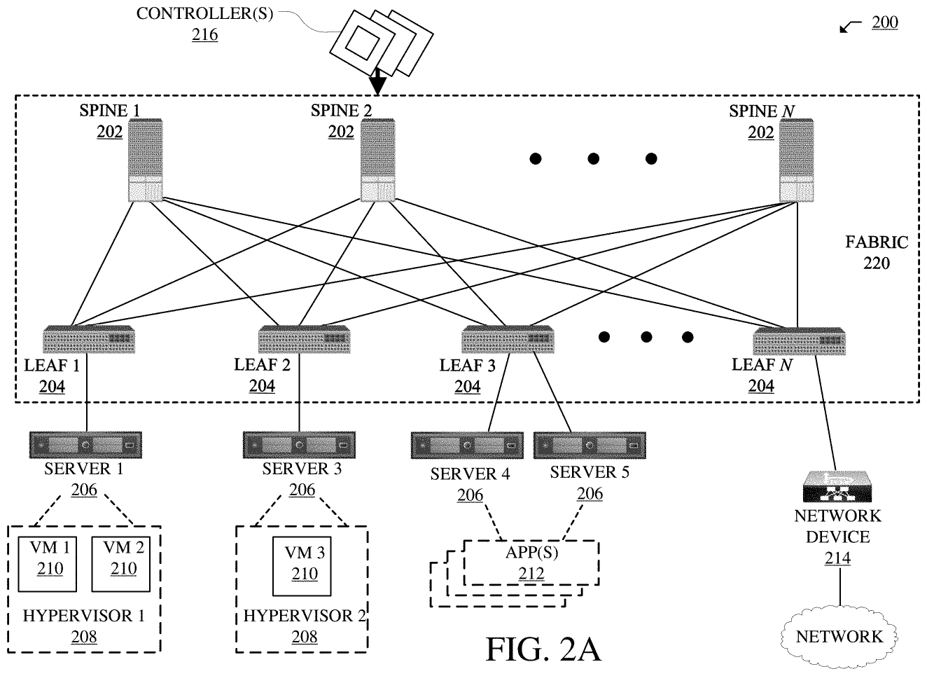

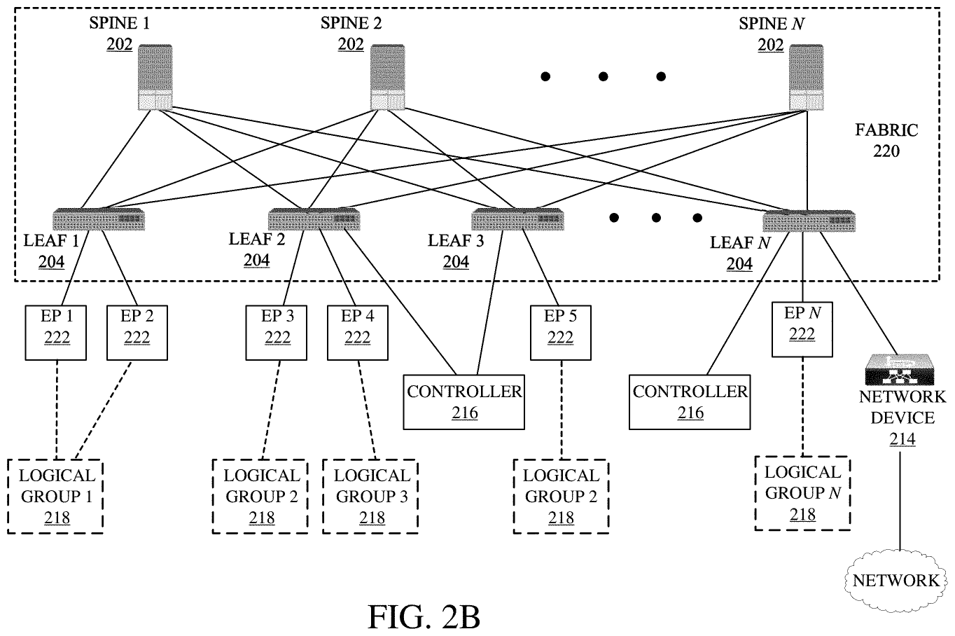

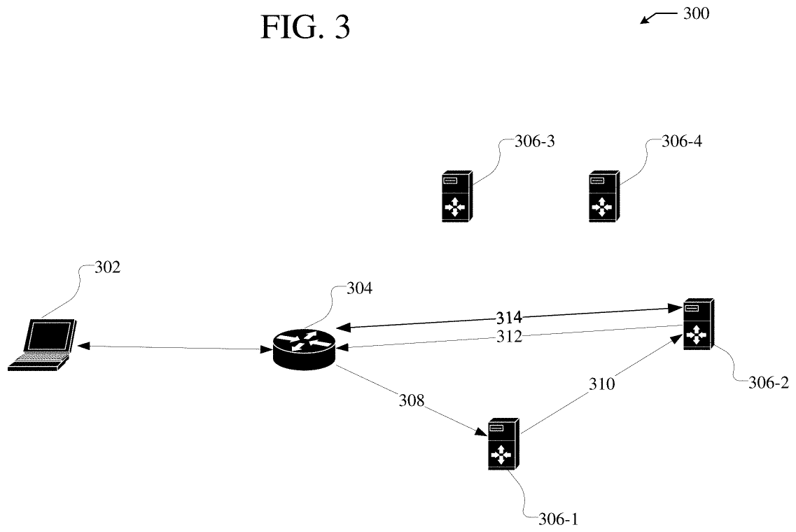

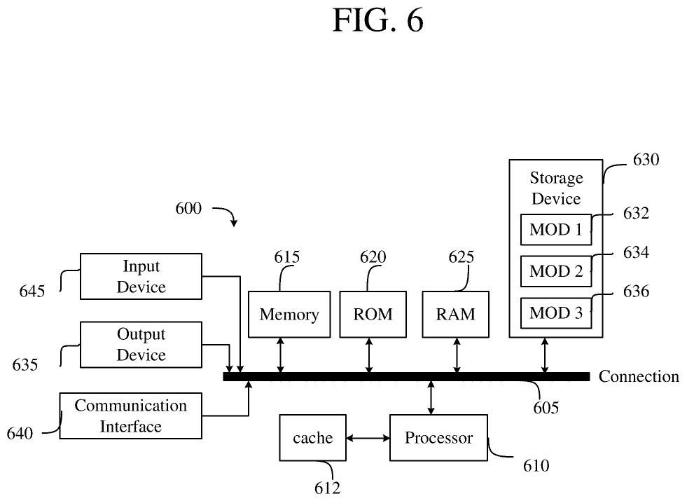

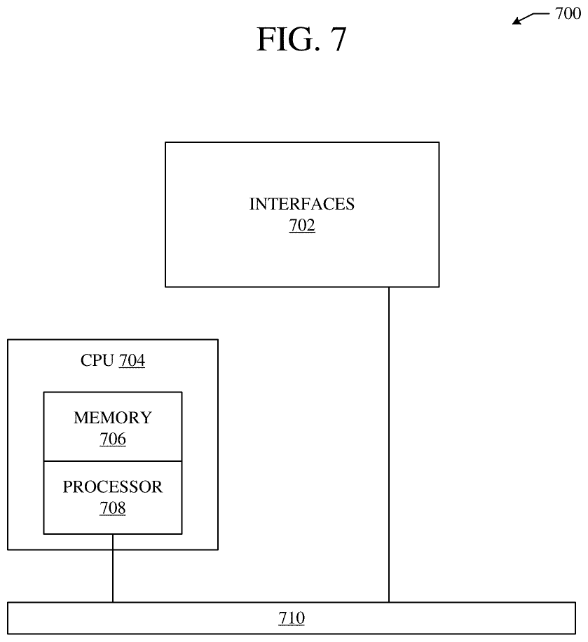

A description of network environments and architectures for network data access and services, as illustrated in FIGS. 1A, 1B, 2A, 2B is first disclosed herein. A discussion of systems, methods, and computer-readable media for load balancing and pre-fetching for network service provisioning as shown in FIGS. 3-5, will then follow. The discussion then concludes with a brief description of example devices, as illustrated in FIGS. 6 and 7. These variations shall be described herein as the various embodiments are set forth. The disclosure now turns to FIG. 1A.

FIG. 1A illustrates a diagram of an example cloud computing architecture 100. The architecture can include a cloud 102. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, a transportation system (e.g., airplane, train, motorcycle, boat, etc.), or any smart or connected object (e.g., smart home, smart building, smart retail, smart glasses, etc.), and so forth.

FIG. 1B illustrates a diagram of an example fog computing architecture 150. The fog computing architecture 150 can include the cloud layer 154, which includes the cloud 102 and any other cloud system or environment, and the fog layer 156, which includes fog nodes 162. The client endpoints 116 can communicate with the cloud layer 154 and/or the fog layer 156. The architecture 150 can include one or more communication links 152 between the cloud layer 154, the fog layer 156, and the client endpoints 116. Communications can flow up to the cloud layer 154 and/or down to the client endpoints 116.

The fog layer 156 or “the fog” provides the computation, storage and networking capabilities of traditional cloud networks, but closer to the endpoints. The fog can thus extend the cloud 102 to be closer to the client endpoints 116. The fog nodes 162 can be the physical implementation of fog networks. Moreover, the fog nodes 162 can provide local or regional services and/or connectivity to the client endpoints 116. As a result, traffic and/or data can be offloaded from the cloud 102 to the fog layer 156 (e.g., via fog nodes 162). The fog layer 156 can thus provide faster services and/or connectivity to the client endpoints 116, with lower latency, as well as other advantages such as security benefits from keeping the data inside the local or regional network(s).

The fog nodes 162 can include any networked computing devices, such as servers, switches, routers, controllers, cameras, access points, gateways, etc. Moreover, the fog nodes 162 can be deployed anywhere with a network connection, such as a factory floor, a power pole, alongside a railway track, in a vehicle, on an oil rig, in an airport, on an aircraft, in a shopping center, in a hospital, in a park, in a parking garage, in a library, etc.

In some configurations, one or more fog nodes 162 can be deployed within fog instances 158, 160. The fog instances 158, 158 can be local or regional clouds or networks. For example, the fog instances 156, 158 can be a regional cloud or data center, a local area network, a network of fog nodes 162, etc. In some configurations, one or more fog nodes 162 can be deployed within a network, or as standalone or individual nodes, for example. Moreover, one or more of the fog nodes 162 can be interconnected with each other via links 164 in various topologies, including star, ring, mesh or hierarchical arrangements, for example.

In some cases, one or more fog nodes 162 can be mobile fog nodes. The mobile fog nodes can move to different geographical locations, logical locations or networks, and/or fog instances while maintaining connectivity with the cloud layer 154 and/or the endpoints 116. For example, a particular fog node can be placed in a vehicle, such as an aircraft or train, which can travel from one geographical location and/or logical location to a different geographical location and/or logical location. In this example, the particular fog node may connect to a particular physical and/or logical connection point with the cloud 154 while located at the starting location and switch to a different physical and/or logical connection point with the cloud 154 while located at the destination location. The particular fog node can thus move within particular clouds and/or fog instances and, therefore, serve endpoints from different locations at different times.

FIG. 2A illustrates a diagram of an example Network Environment 200, such as a data center. In some cases, the Network Environment 200 can include a data center, which can support and/or host the cloud 102. The Network Environment 200 can include a Fabric 220 which can represent the physical layer or infrastructure (e.g., underlay) of the Network Environment 200. Fabric 220 can include Spines 202 (e.g., spine routers or switches) and Leafs 204 (e.g., leaf routers or switches) which can be interconnected for routing or switching traffic in the Fabric 220. Spines 202 can interconnect Leafs 204 in the Fabric 220, and Leafs 204 can connect the Fabric 220 to an overlay or logical portion of the Network Environment 200, which can include application services, servers, virtual machines, containers, endpoints, etc. Thus, network connectivity in the Fabric 220 can flow from Spines 202 to Leafs 204, and vice versa. The interconnections between Leafs 204 and Spines 202 can be redundant (e.g., multiple interconnections) to avoid a failure in routing. In some embodiments, Leafs 204 and Spines 202 can be fully connected, such that any given Leaf is connected to each of the Spines 202, and any given Spine is connected to each of the Leafs 204. Leafs 204 can be, for example, top-of-rack (“ToR”) switches, aggregation switches, gateways, ingress and/or egress switches, provider edge devices, and/or any other type of routing or switching device.

Leafs 204 can be responsible for routing and/or bridging tenant or customer packets and applying network policies or rules. Network policies and rules can be driven by one or more Controllers 216, and/or implemented or enforced by one or more devices, such as Leafs 204. Leafs 204 can connect other elements to the Fabric 220. For example, Leafs 204 can connect Servers 206, Hypervisors 208, Virtual Machines (VMs) 210, Applications 212, Network Device 214, etc., with Fabric 220. Such elements can reside in one or more logical or virtual layers or networks, such as an overlay network. In some cases, Leafs 204 can encapsulate and decapsulate packets to and from such elements (e.g., Servers 206) in order to enable communications throughout Network Environment 200 and Fabric 220. Leafs 204 can also provide any other devices, services, tenants, or workloads with access to Fabric 220. In some cases, Servers 206 connected to Leafs 204 can similarly encapsulate and decapsulate packets to and from Leafs 204. For example, Servers 206 can include one or more virtual switches or routers or tunnel endpoints for tunneling packets between an overlay or logical layer hosted by, or connected to, Servers 206 and an underlay layer represented by Fabric 220 and accessed via Leafs 204.

Applications 212 can include software applications, services, containers, appliances, functions, service chains, etc. For example, Applications 212 can include a firewall, a database, a CDN server, an IDS/IPS, a deep packet inspection service, a message router, a virtual switch, etc. An application from Applications 212 can be distributed, chained, or hosted by multiple endpoints (e.g., Servers 206, VMs 210, etc.), or may run or execute entirely from a single endpoint.

VMs 210 can be virtual machines hosted by Hypervisors 208 or virtual machine managers running on Servers 206. VMs 210 can include workloads running on a guest operating system on a respective server. Hypervisors 208 can provide a layer of software, firmware, and/or hardware that creates, manages, and/or runs the VMs 210. Hypervisors 208 can allow VMs 210 to share hardware resources on Servers 206, and the hardware resources on Servers 206 to appear as multiple, separate hardware platforms. Moreover, Hypervisors 208 on Servers 206 can host one or more VMs 210.

In some cases, VMs 210 and/or Hypervisors 208 can be migrated to other Servers 206. Servers 206 can similarly be migrated to other locations in Network Environment 200. For example, a server connected to a specific leaf can be changed to connect to a different or additional leaf. Such configuration or deployment changes can involve modifications to settings, configurations and policies that are applied to the resources being migrated as well as other network components.

In some cases, one or more Servers 206, Hypervisors 208, and/or VMs 210 can represent or reside in a tenant or customer space. Tenant space can include workloads, services, applications, devices, networks, and/or resources that are associated with one or more clients or subscribers. Accordingly, traffic in Network Environment 200 can be routed based on specific tenant policies, spaces, agreements, configurations, etc. Moreover, addressing can vary between one or more tenants. In some configurations, tenant spaces can be divided into logical segments and/or networks and separated from logical segments and/or networks associated with other tenants. Addressing, policy, security and configuration information between tenants can be managed by Controllers 216, Servers 206, Leafs 204, etc.

Configurations in Network Environment 200 can be implemented at a logical level, a hardware level (e.g., physical), and/or both. For example, configurations can be implemented at a logical and/or hardware level based on endpoint or resource attributes, such as endpoint types and/or application groups or profiles, through a software-defined network (SDN) framework (e.g., Application-Centric Infrastructure (ACI) or VMWARE NSX). To illustrate, one or more administrators can define configurations at a logical level (e.g., application or software level) through Controllers 216, which can implement or propagate such configurations through Network Environment 200. In some examples, Controllers 216 can be Application Policy Infrastructure Controllers (APICs) in an ACI framework. In other examples, Controllers 216 can be one or more management components for associated with other SDN solutions, such as NSX Managers.

Such configurations can define rules, policies, priorities, protocols, attributes, objects, etc., for routing and/or classifying traffic in Network Environment 200. For example, such configurations can define attributes and objects for classifying and processing traffic based on Endpoint Groups (EPGs), Security Groups (SGs), VM types, bridge domains (BDs), virtual routing and forwarding instances (VRFs), tenants, priorities, firewall rules, etc. Other example network objects and configurations are further described below. Traffic policies and rules can be enforced based on tags, attributes, or other characteristics of the traffic, such as protocols associated with the traffic, EPGs associated with the traffic, SGs associated with the traffic, network address information associated with the traffic, etc. Such policies and rules can be enforced by one or more elements in Network Environment 200, such as Leafs 204, Servers 206, Hypervisors 208, Controllers 216, etc. As previously explained, Network Environment 200 can be configured according to one or more particular software-defined network (SDN) solutions, such as CISCO ACI or VMWARE NSX. These example SDN solutions are briefly described below.

ACI can provide an application-centric or policy-based solution through scalable distributed enforcement. ACI supports integration of physical and virtual environments under a declarative configuration model for networks, servers, services, security, requirements, etc. For example, the ACI framework implements EPGs, which can include a collection of endpoints or applications that share common configuration requirements, such as security, QoS, services, etc. Endpoints can be virtual/logical or physical devices, such as VMs, containers, hosts, or physical servers that are connected to Network Environment 200. Endpoints can have one or more attributes such as a VM name, guest OS name, a security tag, application profile, etc. Application configurations can be applied between EPGs, instead of endpoints directly, in the form of contracts. Leafs 204 can classify incoming traffic into different EPGs. The classification can be based on, for example, a network segment identifier such as a VLAN ID, VXLAN Network Identifier (VNID), NVGRE Virtual Subnet Identifier (VSID), MAC address, IP address, etc.

In some cases, classification in the ACI infrastructure can be implemented by Application Virtual Switches (AVS), which can run on a host, such as a server or switch. For example, an AVS can classify traffic based on specified attributes, and tag packets of different attribute EPGs with different identifiers, such as network segment identifiers (e.g., VLAN ID). Finally, Leafs 204 can tie packets with their attribute EPGs based on their identifiers and enforce policies, which can be implemented and/or managed by one or more Controllers 216. Leaf 204 can classify to which EPG the traffic from a host belongs and enforce policies accordingly.

Another example SDN solution is based on VMWARE NSX. With VMWARE NSX, hosts can run a distributed firewall (DFW) which can classify and process traffic. Consider a case where three types of VMs, namely, application, database and web VMs, are put into a single layer-2 network segment. Traffic protection can be provided within the network segment based on the VM type. For example, HTTP traffic can be allowed among web VMs, and disallowed between a web VM and an application or database VM. To classify traffic and implement policies, VMWARE NSX can implement security groups, which can be used to group the specific VMs (e.g., web VMs, application VMs, database VMs). DFW rules can be configured to implement policies for the specific security groups. To illustrate, in the context of the previous example, DFW rules can be configured to block HTTP traffic between web, application, and database security groups.

Returning now to FIG. 2A, Network Environment 200 can deploy different hosts via Leafs 204, Servers 206, Hypervisors 208, VMs 210, Applications 212, and Controllers 216, such as VMWARE ESXi hosts, WINDOWS HYPER-V hosts, bare metal physical hosts, etc. Network Environment 200 may interoperate with a variety of Hypervisors 208, Servers 206 (e.g., physical and/or virtual servers), SDN orchestration platforms, etc. Network Environment 200 may implement a declarative model to allow its integration with application design and holistic network policy.

Controllers 216 can provide centralized access to fabric information, application configuration, resource configuration, application-level configuration modeling for a software-defined network (SDN) infrastructure, integration with management systems or servers, etc. Controllers 216 can form a control plane that interfaces with an application plane via northbound APIs and a data plane via southbound APIs.

As previously noted, Controllers 216 can define and manage application-level model(s) for configurations in Network Environment 200. In some cases, application or device configurations can also be managed and/or defined by other components in the network. For example, a hypervisor or virtual appliance, such as a VM or container, can run a server or management tool to manage software and services in Network Environment 200, including configurations and settings for virtual appliances.

As illustrated above, Network Environment 200 can include one or more different types of SDN solutions, hosts, etc. For the sake of clarity and explanation purposes, various examples in the disclosure will be described with reference to an ACI framework, and Controllers 216 may be interchangeably referenced as controllers, APICs, or APIC controllers. However, it should be noted that the technologies and concepts herein are not limited to ACI solutions and may be implemented in other architectures and scenarios, including other SDN solutions as well as other types of networks which may not deploy an SDN solution.

Further, as referenced herein, the term “hosts” can refer to Servers 206 (e.g., physical or logical), Hypervisors 208, VMs 210, containers (e.g., Applications 212), etc., and can run or include any type of server or application solution. Non-limiting examples of “hosts” can include virtual switches or routers, such as distributed virtual switches (DVS), application virtual switches (AVS), vector packet processing (VPP) switches; VCENTER and NSX MANAGERS; bare metal physical hosts; HYPER-V hosts; VMs; DOCKER Containers; etc.

FIG. 2B illustrates another example of Network Environment 200. In this example, Network Environment 200 includes Endpoints 222 connected to Leafs 204 in Fabric 220. Endpoints 222 can be physical and/or logical or virtual entities, such as servers, clients, VMs, hypervisors, software containers, applications, resources, network devices, workloads, etc. For example, an Endpoint 222 can be an object that represents a physical device (e.g., server, client, switch, etc.), an application (e.g., web application, database application, etc.), a logical or virtual resource (e.g., a virtual switch, a virtual service appliance, a virtualized network function (VNF), a VM, a service chain, etc.), a container running a software resource (e.g., an application, an appliance, a VNF, a service chain, etc.), storage, a workload or workload engine, etc. Endpoints 122 can have an address (e.g., an identity), a location (e.g., host, network segment, virtual routing and forwarding (VRF) instance, domain, etc.), one or more attributes (e.g., name, type, version, patch level, OS name, OS type, etc.), a tag (e.g., security tag), a profile, etc.

Endpoints 222 can be associated with respective Logical Groups 218. Logical Groups 218 can be logical entities containing endpoints (physical and/or logical or virtual) grouped together according to one or more attributes, such as endpoint type (e.g., VM type, workload type, application type, etc.), one or more requirements (e.g., policy requirements, security requirements, QoS requirements, customer requirements, resource requirements, etc.), a resource name (e.g., VM name, application name, etc.), a profile, platform or operating system (OS) characteristics (e.g., OS type or name including guest and/or host OS, etc.), an associated network or tenant, one or more policies, a tag, etc. For example, a logical group can be an object representing a collection of endpoints grouped together. To illustrate, Logical Group 1 can contain client endpoints, Logical Group 2 can contain web server endpoints, Logical Group 3 can contain application server endpoints, Logical Group N can contain database server endpoints, etc. In some examples, Logical Groups 218 are EPGs in an ACI environment and/or other logical groups (e.g., SGs) in another SDN environment.

Traffic to and/or from Endpoints 222 can be classified, processed, managed, etc., based Logical Groups 218. For example, Logical Groups 218 can be used to classify traffic to or from Endpoints 222, apply policies to traffic to or from Endpoints 222, define relationships between Endpoints 222, define roles of Endpoints 222 (e.g., whether an endpoint consumes or provides a service, etc.), apply rules to traffic to or from Endpoints 222, apply filters or access control lists (ACLs) to traffic to or from Endpoints 222, define communication paths for traffic to or from Endpoints 222, enforce requirements associated with Endpoints 222, implement security and other configurations associated with Endpoints 222, etc.

In an ACI environment, Logical Groups 218 can be EPGs used to define contracts in the ACI. Contracts can include rules specifying what and how communications between EPGs take place. For example, a contract can define what provides a service, what consumes a service, and what policy objects are related to that consumption relationship. A contract can include a policy that defines the communication path and all related elements of a communication or relationship between endpoints or EPGs. For example, a Web EPG can provide a service that a Client EPG consumes, and that consumption can be subject to a filter (ACL) and a service graph that includes one or more services, such as firewall inspection services and server load balancing.

As discussed previously, network-based services (e.g. databases, web apps, APIs, . . . ) tend to function in a reactive fashion. Load-balancers dispatch connections to different servers with a variable level of awareness of the servers load, and the servers then perform best effort to accommodate clients. In particular, in micro-services-based architectures, an initial query generally results in a large number of back-end connections, which are each load-balanced and served by application servers in a very reactive fashion. This approach may cause additional latency due to servers already being loaded at the time they receive a request, while other servers might have available resources. There therefore exist needs for systems and methods of load balancing and reducing latency in network service provisioning.

The present includes systems, methods, and computer-readable media for load balancing across servers in a network environment and pre-fetching resources to decrease latency. Traffic in a network environment for providing access to network services through the network environment is monitored. A related network service associated with a requested network service recognized by monitoring the traffic in the network environment can be identified. A UDP probe for the related network service can be sent within the network environment to at least one of a plurality of candidate servers for provisioning the related network service. Further, a candidate server of the plurality of candidate servers can be assigned to provision the related network service in response to the candidate server accepting provisioning of the related network service based on the UDP probe. Additionally, the candidate server can be configured to gather one or more pre-fetched resources for provisioning the related network service. Subsequently, a load balancer of the network environment can steer traffic associated with provisioning of the related network service to the candidate server for provisioning of the related network service using the one or more pre-fetched resources.

FIG. 3 shows an example network environment 300 for performing load balancing and pre-fetching for network services provided through the network environment 300. The example network environment 300 includes a client 302, a load balancer 304, a first server 306-1, a second server 306-2, a third server 306-3, and a fourth server 306-4 (servers 306). While the servers 306 are shown to include four servers, in various embodiments the systems and techniques described herein can be implemented with less than four servers or with more than four servers. The network environment 300 can be formed, at least in part, through an applicable cloud or fog environment, such as the cloud computing architecture 100 shown in FIG. 1A and the fog computing architecture 150 shown in FIG. 1B. Further, the network environment 300 can be formed, at least in part, through an applicable network environment, such as the network environment 200 shown in FIGS. 2A and 2B. For example, the load balancer 304 and the servers 306 can be implemented in a data center formed by the network environment 200 shown in FIG. 2A.

The load balancer 304 functions to perform load balancing across the servers 306 to provide network services to one or more clients, e.g. the client 302. Specifically, the load balancer 304 can perform load balancing by modifying UDP packets for requested network services that are received from clients. As will be discussed in greater detail later, the load balancer 304 can perform load balancing by inserting a SRv6 header into a received UDP packet. The SRv6 header and the corresponding UDP packet can then be used to assign a server of a plurality of candidate servers to provision a network service, effectively load balancing across a plurality of servers including the plurality of candidate servers. The process of assigning a candidate server to provision a network service by modifying a received UDP packet can occur before a connection for providing the service to a client is actually opened. For example, a candidate server for provisioning a network service can be assigned before a Transmission Control Protocol (TCP) connection for providing the service to a client is actually opened. In turn, this can reduce latency and improve overall network efficiency by reducing, or otherwise eliminating, the time between when a connection for providing a service is opened and when a server is actually assigned to provide the service.

Further, and as will be discussed in greater detail later, an assigned server can pre-fetch data/resources for providing a network service. Specifically, an assigned server can pre-fetch data for providing a network service before a connection, e.g. a TCP connection, is established with a client for providing the service to the client. In turn, once the connection is established, the assigned server can begin providing the network service using the pre-fetched data without having to gather data to begin and continue providing the network service. This can further reduce latency and improve overall network efficiency by facilitating faster network service provisioning. Pre-fetched resources/data, as described herein, can include applicable data for providing access to network services. For example, pre-fetched resources can include portions of an application executed as part of providing network service access.

Network services, as described herein, include applicable services provided through a network environment. Further, network services can include micro-services. A micro-service can include a component of an application that is structured according to a micro-service architecture. Further a micro-service can loosely couple with other micro-services in a micro-service architecture to perform tasks of an application.

Returning back to the example network environment 300 shown in FIG. 3, the load balancer 304 receives a request for a network service from the client 302. The request can include a UDP packet requesting access to a network service. The network service can be identified by a virtual IP address (VIP), and the client 302 can attempt to access the network service, e.g. send and receive data of the network service, through a TCP connection. Before sending a TCP SYN for establishing the TCP connection, the client 302 can emit a UDP packet for the network service to the VIP. Specifically, the client 302 can emit the UDP packet with the same source/destination UDP ports for the TCP SYN, but before the TCP SYN is sent from the client. Further, the UDP packet can be sent with applicable encrypted information, e.g. a client ID of the client 302. The encrypted information can be encrypted using an applicable encryption technique, e.g. using a public key. This can prevent leaking of sensitive information, e.g. the client ID, as a result of transmission of the UDP packet.

The load balancer 304 can receive, or otherwise catch, the UDP packet for the network service transmitted by the client 302. Specifically, the load balancer 304 can be configured to advertise the VIP using an applicable routing information exchange protocol, e.g. Border Gateway Protocol (BGP). As follows, the load balancer 304 can receive the UDP packet once it is transmitted from the client 302. More specifically, the load balancer 304 can receive the UDP packet for the network service before receiving the TCP SYN and subsequently before the TCP connection is established with the client 302.

After receiving the UDP packet, the load balancer 304 can modify the UDP packet for purposes of load balancing provisioning of network services, including the requested network service, across a plurality of servers, including the servers 306. Specifically, the load balancer can insert a SRv6 header containing a list of candidate servers, e.g. the servers 306, into the UDP packet. A candidate server is a server that is capable of provisioning a network service, e.g. the requested network service, to a client. Each candidate server can be identified by a unique identifier, e.g. a MAC address or an IP address, of the candidate server in the list of candidate servers. The load balancer 304 can use an applicable mechanism to insert a SRv6 header into the UDP packet. For example, the load balancer 304 can use a T.INSERT SRv6 policy to insert a SRv6 header into the UDP packet.

The load balancer 304 can then send, at step 308, the modified UDP packet to the first server 306-1 of the plurality of servers 306. Specifically, the load balancer 304 can send the modified UDP packet to the first server 306-1 as part of load balancing provisioning of the network service by one of the plurality of servers 306. After receiving the modified UDP packet, the first server 306-1 can use the modified UDP packet to determine whether it can provision the requested network service to the client 302. Specifically, the first server 306-1 can determine whether it can provision the requested network service based on computational resources available at the first server 306-1 for provisioning the network service. For example, the first server 306-1 can determine whether it can provision the requested network service based on its individual and instantaneous load level in providing access to network services.

If a candidate server determines that it cannot provision a requested network service, e.g. based on its load level, then the candidate server can forward the modified UDP packet to another candidate server. Specifically, a candidate server can forward the modified UDP packet to another candidate server in the list of candidate servers included in the modified UDP packet if the candidate server determines that it is unable to provide access to the requested network service. The another candidate server can then receive the modified UDP packet and determine whether it is able to provide access to the requested network service. If the another candidate server determines that it cannot provide access to the requested network service, then the candidate server can forward the modified UDP packet to yet another candidate server. This process can repeat itself until a candidate server accepts provisioning of the network service to the client 302. Specifically, the candidate servers can forward the modified UDP packet to other candidate servers sequentially according to the order of the candidate servers in the list of candidate servers included in the modified UDP packet.

With respect to the example network environment 300 shown in FIG. 3, the first server 306-1 can receive, at step 308, the modified UDP packet from the load balancer 304. The first server 306-1 can then determine that it cannot provision the requested network service to the client 302. Subsequently, the first server 306-1 can send, at step 310, the modified UDP packet to the second server 306-2. The second server 306-2 can then determine that it is able to provision the requested network service to the client 302. Specifically, the second server 306-2 can determine that it has available computational resources, e.g. based on its individual and instantaneous load level, to provision the requested network service to the client 302.

While the second server 306-2 is depicted as accepting provisioning of the requested network service, if the second server 306-2 determines that it cannot provision the network service, then it can send the modified UDP packet to the third server 306-3. The third server 306-3 can then determine whether it is able to provision the requested network service to the client 302. If the third server 306-3 determines that it is unable to provision the requested network service, then the third server 306-3 can forward the modified UDP packet to the fourth server 306-4. The fourth server 306-4 can then determine whether it is able to provision the requested network service. In various embodiments, if all of the candidate servers, e.g. the servers 306, are unable to provision a network service, a container/virtual machine can be created for provisioning the requested network service to the client. The container can pre-fetch data for provisioning the requested network service to the client 302. Specifically, the container can pre-fetch data according to the techniques that will be discussed in greater detail later. This can further reduce network latency in providing the requested network service.

Returning back to the scenario in the example environment 300 shown in FIG. 3, the second server 306-2 determines that it is capable of provisioning the requested network service to the client 302. Accordingly, the second server 306-2 can accept provisioning of the requested network service and begin pre-fetching data for provisioning the requested network service to the client 302. Specifically, the second server 306-2 can decrypt the client identifier included in the packet, and use the client identifier to pre-fetch data that can be used to fill actual requests later sent by the client. The second server 306-2 can pre-fetch data for provisioning the requested network service before a connection is established with the client 302 for actually providing the requested network service to the client 302. For example, the second server 306-2 can pre-fetch the data before a TCP connection is established with the client 302 for provisioning the requested network service to the client.

In various embodiments, the second server 306-2 can pre-fetch data in a similar manner to how the load balancer 304 performs load balancing of the requested service across the servers 306. Specifically, if data that will be pre-fetched depends on other services, then the second server 306-2 can probe the dependent services for the data by sending a probe for the data to a dependent service of the dependent services. Subsequently, the dependent service can either provide the data to the second server 306-2 or forward the probe to another dependent service of the dependent services. As discussed with respect to load balancing of the requested network service, this process can repeat until a dependent service is capable of providing and actually provides the pre-fetched data back to the second server 306-2. Specifically, the second server 306-2 effectively takes on the role of the client 302 and the dependent services effectively take on the roles of the servers 306.

Further, in accepting provisioning of the requested network service, the second server 306-2 can communicate, at step 312, with the load balancer 304 to inform the load balancer 304 that the second server 306-2 will provision the requested network service to the client 302. Specifically, the second server 306-2 can send an acknowledgement for the requested network service to the load balancer 304 concurrently with the second server 306-2 gathering the pre-fetched data for provisioning the requested network service. In response to the acknowledgement received from the second server 306-2, the load balancer 304 can generate a routing rule at the load balancer 304 for forwarding traffic associated with the requested network service to the second server 306-2. Specifically, the routing rule can associate a 4-tuple of the UDP probe, corresponding to the requested network service, with the second server 306-2. In various embodiments, when a container/virtual machine is set up for providing the requested network service, an infrastructure hypervisor can generate and install a routing rule at the load balancer 304. Specifically, the infrastructure hypervisor can install a routing rule for forwarding traffic associated with the requested network service at the load balancer 304 to a container provisioning the requested network service.

The routing rule can ensure that a “true” forthcoming TCP connection from the client 302 for provisioning the requested network service will be directed towards the second server 306-2 without having to go through the entire list of candidate servers, e.g. the servers 306. Specifically, after sending the UDP packet for the requested network service, the client 302 can open a standard TCP connection towards the VIP using the same 4-tuple as the UDP packet. More specifically, after sending the UDP packet for the requested network service, the client 302 can send a TCP SYN packet to the load balancer 304 using the same 4-tuple as the UDP packet. Based on the created routing rule that associates the second server 306-2 with the 4-tuple of the UDP packet, the load balancer 304 can steer, at step 314, the TCP SYN packet to the second server 306-2. The load balancer 304 can steer the TCP SYN packet according to an applicable mechanism or technique for performing routing or data center load balancing. For example, the load balancer 304 can steer the TCP SYN packet using one of Generic Routing Encapsulation (GRE), SRv6, Multiprotocol Label Switching (MPLS), DiffSery routing, Maglev, and Ananta. As follows, the second server 306-2 can receive the TCP SYN packet and complete the TCP handshake with the client 302. Subsequently, packets transmitted from the client 302 and associated with the requested network service, e.g. having the same 4-tuple, can be steered by the load balancer 304, at step 314, toward the second server 306-2 using the established routing rule.

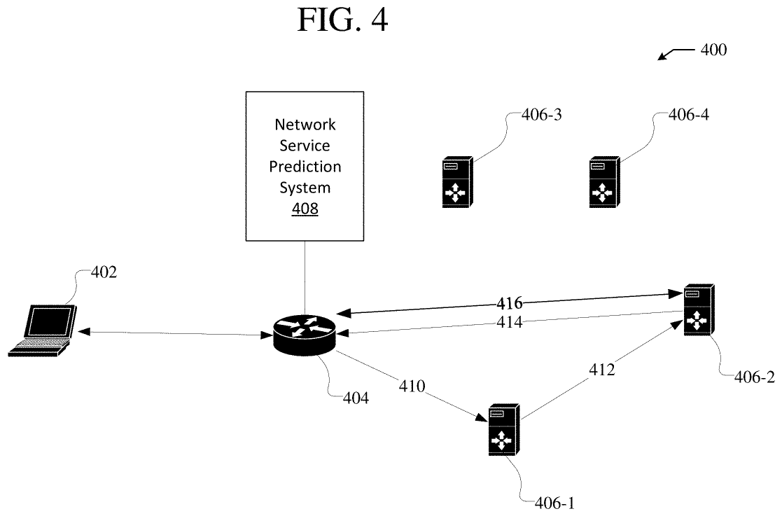

FIG. 4 shows an example network environment 400 for performing load balancing and pre-fetching for predicted network services provided through the network environment 400. The example network environment 400 includes a client 402, a load balancer 404, a first server 406-1, a second server 406-2, a third server 406-3, and a fourth server 406-4 (servers 406). The example network environment 400 also includes a network service prediction system 408. While the servers 406 are shown to include four servers, in various embodiments the systems and techniques described herein can be implemented with less than four servers or with more than four servers. The network environment 400 can be formed, at least in part, through an applicable cloud or fog environment, such as the cloud computing architecture 100 shown in FIG. 1A and the fog computing architecture 150 shown in FIG. 1B. Further, the network environment 400 can be formed, at least in part, through an applicable network environment, such as the network environment 200 shown in FIGS. 2A and 2B. For example, the load balancer 404 and the servers 406 can be implemented in a data center formed by the network environment 200 shown in FIG. 2A.

In the example network environment 400 shown in FIG. 4, the load balancer 404 can receive a request for a network service from the client 402. Specifically, the load balancer 404 can receive a UDP probe for the network service from the client 402. Subsequently, in the same manner as discussed with respect to the network environment 300 in FIG. 3, the load balancer 404 can use the UDP probe to load balance across the servers 406 for provisioning the requested network service to the client 402. Specifically, the load balancer 404 can modify the UDP probe to include a list of candidate servers including the servers 406 and send the modified UDP probe to one of the candidate servers. The servers 406 can then forward the UDP probe until one of the candidate servers acknowledges that it will provision the requested service to the client 402. Alternatively, if none of the candidate servers agrees to provision the requested network service to the client 402, then a container can be created for provisioning the requested network service to the client 402. Further, in the same manner as discussed with respect to the network environment 300 shown in FIG. 3, data for provisioning the requested service to the client 402 can be pre-fetched by a server that agrees to provision the requested service.

The example network environment 400 can also be used to identify a related network service associated with the service requested by the client 402. Specifically, the network service prediction system 408 can identify the related network service associated with the service requested by the client 402. The network service prediction system 408 can identify the related network service by monitoring network traffic passing through the network environment 400, e.g. through the load balancer 404. In particular, the network service prediction system 408 can identify the related network service from a UDP probe sent from the client 402 for the requested network service. Further, the network service prediction system 408, as will be discussed in greater detail later with respect to the example of maintaining a temporal dependency mapping, can identify the related network service from other types of traffic issued by the client 402.

As will be discussed in greater detail later, the load balancer 404 can then manage load balancing of the related network service across the servers 406. Further, data for provisioning the related network service can be pre-fetched. In identifying, load balancing the associated network service, and pre-fetching data for the associated network service, the example environment 400 can facilitate decreased network latency and improved network efficiency. Specifically, the environment 400 can be configured to provision services before they are even requested, thereby reducing latency associated with configuring the environment 400 to provision services after the services are requested.

The network service prediction system 408 can function to predict the related network service based on a temporal dependency mapping of network services provisioned through the network environment 400. Specifically, the network service prediction system 408 can maintain a temporal dependency mapping of network services, e.g. including the requested network service and the related network service, for purposes of determining the related network service from network traffic associated with the requested network service. A temporal dependency mapping, as used herein, can include mappings associating different network services based on time. The network service prediction system 408 can maintain the temporal dependency mapping of network services using an applicable technique, such as network traces, on-line observations, and configuration files.

In an example of maintaining a temporal dependency mapping, an application C can always perform a DNS request to application A, before issuing an HTTP request to application B. Accordingly, the network service prediction system 408 can learn, and subsequently create an application dependency mapping indicating that before application C issues an HTTP request to application B, it issues a DNS request to application A. As will be discussed in greater detail later, using the network service prediction system 408, when a DNS query to application A is observed, then the infrastructure can trigger resource allocation in advance, e.g. pre-fetch content, etc, and configure the load balancer 404 to steer a forthcoming HTTP flow from application C to these newly-allocated resources.

The network service prediction system 408 can maintain temporal dependency mappings based on service to service delay distributions. Specifically, the network service prediction system 408 can analyze traffic in the network information to extract per-flow traffic information of traffic flows forming the traffic. Per-flow information can include applicable information related to traffic flows in providing network services, such as the type and subject of data transmitted through each flow of the traffic flows. The network service prediction system 408 can then translate the per-flow information into per-service information. For example, the network service prediction system 408 can aggregate flow information over well-known addresses and ports compared to ephemeral ports and client addresses to create a matrix of service to service delay distributions.

The network service prediction system 408 can then analyze the delay between services, e.g. as indicated by the per-service information, to generate a temporal dependency mapping of related network services. For example, if temporal delay distributions of services are rather uniform over time, then the network service prediction system 408 can determine that the services are unrelated. Conversely, if temporal delay distributions of services are not uniform and vary over time, then the network service prediction system 408 can determine that the services are related. Subsequently, the network service prediction system 408 can update the temporal dependency mappings to reflect the correlation between services, as determined based on temporal delay distributions appearing to vary over time.

After determining the related network service, the network environment 400 can be configured to perform load balancing of the related network service across the servers 406. Specifically, the network environment 400 can be configured to perform load balancing of the related network services across the servers 406 in a manner similar to the techniques described with respect to the network environment 300 shown in FIG. 3. The load balancing can be performed before either or both the requested network service and the related network service are provisioned to the client 402. Additionally, the load balancing can be performed before a connection is established for provisioning the requested network service to the client 402. Further, the load balancing can be performed before a connection is established for provisioning the related network service to the client 402.

In order to perform load balancing of the related network service, the load balancer 404 can function to generate a UDP probe for the related network service. The UDP probe can be an internal probe that is originated in and sent within the network environment 400. Specifically, the load balancer 404 can generate the UDP probe for the related network service without the client 402 actually requesting the related network service. Therefore, the UDP probe for the related network service can be generated internally by the load balancer 404 and not by the client 402. The UDP probe can include a header including a list of candidate servers, similar as to the modified UDP probe discussed with respect to the network environment 300 shown in FIG. 3. Specifically, the load balancer 404 can insert a SRv6 header into the UDP probe that includes a list of the candidate servers for provisioning the related network service to the client 402.

The load balancer 404 can then send the UDP probe to a candidate server of the plurality of candidate servers for the related network service. In the example network environment 400 shown in FIG. 4, the load balancer 404 sends the UDP probe, at step 410, to the first server 406-1, e.g. the first candidate server. Similar to the scenario described with respect to the network environment 300 shown in FIG. 3, the first server 406-1 can determine it is unable to provision the related network service using the UDP probe. Specifically, the first server 406-1 can determine it is unable to provision the related network service based on its individual and instantaneous load level in providing access to network services.

Similar to the scenario described with respect to the network environment 300 shown in FIG. 3, at step 412, the first server 406-1 can forward the UDP probe to the second server 406-2. Specifically, the first server 406-1 can forward the UDP probe to the second server 406-2 in response to the first server 406-1 determining that it is unable to provision the related network service. The first server 406-1 can forward the UDP probe to the second server 406-2 using the list of candidate servers included in the UDP probe. The second server 406-2 can then determine that it is capable of provisioning the related network service to the client 402, e.g. based on available computational resources of the second server 406-2 in providing access to network services.

While the second server 406-2 is depicted as accepting provisioning of the related network service, if the second server 406-2 determines that it cannot provision the related network service, then it can send the UDP probe to the third server 406-3. The third server 406-3 can then determine whether it is able to provision the related network service to the client 402. If the third server 406-3 determines that it is unable to provision the related network, then the third server 406-3 can forward the UDP probe to the fourth server 406-4. The fourth server 406-4 can then determine whether it is able to provision the related network service. In various embodiments, if all of the candidate servers, e.g. the servers 406, are unable to provision the related network service, a container/virtual machine can be created for provisioning the related network service to the client 402.

In response to accepting provisioning of the related network service to the client 402, the second server 406-2 can begin to pre-fetch data for use in actually provisioning the related network service to the client 402. The second server 406-2 can pre-fetch data according to the techniques described with respect to the second server 306-2 in the example network environment 300 shown in FIG. 3. Further, the second server 406-2 can pre-fetch data before connections for providing either or both the requested network service and the related network service to the client 402 are actually established with the client 402. For example, the second server 406-2 can pre-fetch data for the related network service before a TCP connection for providing the requested network service to the client 402 is actually established with the client 402.

In accepting provisioning of the related network service, the second server 406-2 can communicate, at step 414, with the load balancer 404 to inform the load balancer 404 that the second server 406-2 will provision the related network service to the client 402. Specifically, the second server 406-2 can send an acknowledgement for the related network service to the load balancer 404 concurrently with the second server 406-2 gathering the pre-fetched data for provisioning the related network service.

In response to the acknowledgement received from the second server 406-2, the load balancer 404 can generate a routing rule at the load balancer 404 for forwarding traffic associated with the related network service to the second server 406-2. Specifically, the routing rule can specify inspecting network traffic from the client 402 to determine a network service associated with the traffic. Further, the routing rule can specify steering network traffic associated with the related network service, as determined by inspecting the network traffic, to the second server 406-2. This routing rule can be different from the routing rule discussed previously with respect to the example environment 300 shown in FIG. 3. Specifically, the previous routing rule can associate the 4-tuple of the UDP probe of the requested service with the second server 306-2. However, as the client 402 has not actually requested the related network service and therefore has not sent a UDP probe with a 4-tuple for the related network service, the routing rule does not associate the 4-tuple of the UDP probe for the related network service with the second server 406-2. Instead, the routing rule can generally associate the related network service with the second server 406-2. Subsequently, the load balancer can use the routing rule to steer, at step 416, traffic, e.g. a TCP SYN, for the related network service toward the second server 406-2. In turn, the second server 406-2 can provision the related network service to the client 402 using pre-fetched data for the related network service.

With respect to the previously described example of maintaining the temporal dependency mapping, the routing rule can match traffic coming from application C and destined for pre-fetched application B to the second server 406-2. Subsequently, the traffic for application B can be steered to the second server 406-2. Accordingly, the second server 406-2 can provision pre-fetched application B to the client 402.

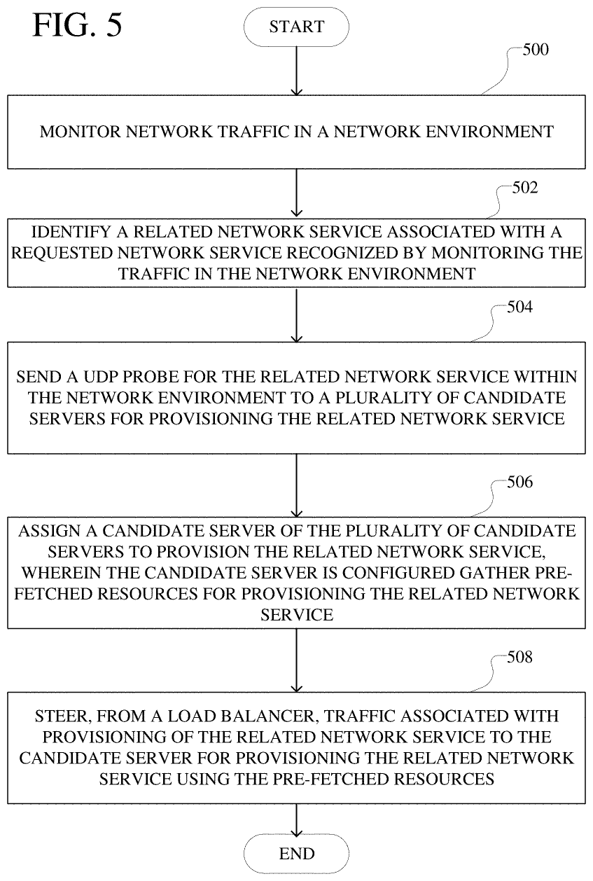

FIG. 5 illustrates a flowchart for an example method of load balancing and pre-fetching data for provisioning a network service related to a requested network service. The method shown in FIG. 5 is provided by way of example, as there are a variety of ways to carry out the method. Additionally, while the example method is illustrated with a particular order of steps, those of ordinary skill in the art will appreciate that FIG. 5 and the modules shown therein can be executed in any order and can include fewer or more modules than illustrated. Each module shown in FIG. 5 represents one or more steps, processes, methods or routines in the method.

At step 500, the network service prediction system 408 monitors network traffic in a network environment. Specifically, the network service prediction system 408 can monitor traffic data sent from a client through the network environment. More specifically, the network service prediction system 408 can monitor UDP probes sent by clients for accessing network services.

At step 502, the network service prediction system 408 identifies a related network service associated with a requested network service by monitoring the traffic in the network environment. Specifically, the network service prediction system can identify a requested network service from a UDP probe sent from a client. Subsequently, the network service prediction system 408 can use a temporal dependency mapping of network service to identify the related network service associated with the requested network service.

At step 504, a UDP probe for the related network service is sent to a plurality of candidate servers in the network environment for provisioning the related network service. Specifically, the load balancer 404 can generate the UDP probe and send the UDP probe to a first candidate server of the plurality of candidate servers. Subsequently, the first candidate server can use the UDP probe to identify a second candidate server and forward the UDP probe to the second candidate server. This process can continue until a candidate server of the plurality of candidate servers agrees provision the related network service.

At step 506, a candidate server of the plurality of candidate servers is assigned to provision the related network service. Specifically, the candidate server can agree to provision the related network service based on available computing resources and accordingly be assigned to provision the related network service. The candidate server can gather pre-fetched data for provisioning the related network service. Specifically, the candidate server can pre-fetch data for provisioning the related network service before a connection for providing the related network service to a client is established.

At step 508, traffic associated with provisioning the related network service is steered to the candidate server. Specifically, traffic can be steered to the candidate server based on a routing rule that associates the candidate server with the related network service. In turn, the candidate server can use the traffic and the pre-fetched resources to provision the related network service to a client.

The disclosure now turns to FIGS. 6 and 7, which illustrate example network devices and computing devices, such as switches, routers, load balancers, client devices, and so forth.

FIG. 6 illustrates a computing system architecture 600 wherein the components of the system are in electrical communication with each other using a connection 605, such as a bus. Exemplary system 600 includes a processing unit (CPU or processor) 610 and a system connection 605 that couples various system components including the system memory 615, such as read only memory (ROM) 620 and random access memory (RAM) 625, to the processor 610. The system 600 can include a cache 612 of high-speed memory connected directly with, in close proximity to, or integrated as part of the processor 610. The system 600 can copy data from the memory 615 and/or the storage device 630 to the cache 612 for quick access by the processor 610. In this way, the cache 612 can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware or software service, such as service 1 632, service 2 634, and service 3 636 stored in storage device 630, configured to control the processor 610 as well as a special-purpose processor where software instructions are incorporated into the actual processor design. The processor 610 may be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include services 632, 634, 636 for controlling the processor 610. Other hardware or software modules are contemplated. The storage device 630 can be connected to the system connection 605. In one aspect, a hardware module that performs a particular function can include the software component stored in a computer-readable medium in connection with the necessary hardware components, such as the processor 610, connection 605, output device 635, and so forth, to carry out the function.

FIG. 7 illustrates an example network device 700 suitable for performing switching, routing, load balancing, and other networking operations. Network device 700 includes a central processing unit (CPU) 704, interfaces 702, and a bus 710 (e.g., a PCI bus). When acting under the control of appropriate software or firmware, the CPU 704 is responsible for executing packet management, error detection, and/or routing functions. The CPU 704 preferably accomplishes all these functions under the control of software including an operating system and any appropriate applications software. CPU 704 may include one or more processors 708, such as a processor from the INTEL X86 family of microprocessors. In some cases, processor 708 can be specially designed hardware for controlling the operations of network device 700. In some cases, a memory 706 (e.g., non-volatile RAM, ROM, etc.) also forms part of CPU 704. However, there are many different ways in which memory could be coupled to the system.

The interfaces 702 are typically provided as modular interface cards (sometimes referred to as “line cards”). Generally, they control the sending and receiving of data packets over the network and sometimes support other peripherals used with the network device 700. Among the interfaces that may be provided are Ethernet interfaces, frame relay interfaces, cable interfaces, DSL interfaces, token ring interfaces, and the like. In addition, various very high-speed interfaces may be provided such as fast token ring interfaces, wireless interfaces, Ethernet interfaces, Gigabit Ethernet interfaces, ATM interfaces, HSSI interfaces, POS interfaces, FDDI interfaces, WIFI interfaces, 3G/4G/5G cellular interfaces, CAN BUS, LoRA, and the like. Generally, these interfaces may include ports appropriate for communication with the appropriate media. In some cases, they may also include an independent processor and, in some instances, volatile RAM. The independent processors may control such communications intensive tasks as packet switching, media control, signal processing, crypto processing, and management. By providing separate processors for the communications intensive tasks, these interfaces allow the master CPU 704 to efficiently perform routing computations, network diagnostics, security functions, etc.

Although the system shown in FIG. 7 is one specific network device of the present technology, it is by no means the only network device architecture on which the present technology can be implemented. For example, an architecture having a single processor that handles communications as well as routing computations, etc., is often used. Further, other types of interfaces and media could also be used with the network device 700.

Regardless of the network device's configuration, it may employ one or more memories or memory modules (including memory 706) configured to store program instructions for the general-purpose network operations and mechanisms for roaming, route optimization and routing functions described herein. The program instructions may control the operation of an operating system and/or one or more applications, for example. The memory or memories may also be configured to store tables such as mobility binding, registration, and association tables, etc. Memory 706 could also hold various software containers and virtualized execution environments and data.

The network device 700 can also include an application-specific integrated circuit (ASIC), which can be configured to perform routing and/or switching operations. The ASIC can communicate with other components in the network device 700 via the bus 710, to exchange data and signals and coordinate various types of operations by the network device 700, such as routing, switching, and/or data storage operations, for example.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, media, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

1. A method comprising:
monitoring traffic in a network environment for providing access to network services through the network environment;
identifying a requested network service for a client
identifying a related network service associated with the requested network service recognized by monitoring the traffic in the network environment, wherein the related network service is identified before the related network service is requested by the client;
sending a User Datagram Protocol (UDP) probe for the related network service within the network environment to at least one candidate server of a plurality of candidate servers for provisioning the related network service;
assigning a candidate server of the plurality of candidate servers to provision the related network service in response to the candidate server accepting provisioning of the related network service based on the UDP probe, wherein the candidate server is configured to gather, before the related network service is requested by the client, one or more pre-fetched resources for provisioning the related network service;
receiving a request for the related network service from the client either concurrently with provisioning of the requested network service or after the provisioning of the requested network service; and
steering, from a load balancer of the network environment, traffic associated with provisioning of the related network service to the candidate server for provisioning of the related network service using the one or more pre-fetched resources.

2. The method of claim 1, wherein the one or more pre-fetched resources are gathered as the requested network service is provisioned and before the related network service is provisioned.

3. The method of claim 1, wherein the candidate server is configured to accept provisioning of the related network service from within the plurality of candidate servers based on an amount of instantaneous resources available at each of the plurality of candidate servers for provisioning the related network service.

4. The method of claim 1, wherein the UDP probe is an internal probe that is originated in and sent within the network environment.

5. The method of claim 1, wherein the UDP probe includes an SRv6 header identifying the plurality of candidate servers.

6. The method of claim 1, wherein the UDP probe is passed sequentially along the plurality of candidate servers until the candidate server accepts provisioning of the related network service.

7. The method of claim 1, wherein the load balancer is configured to set up a rule for forwarding the traffic associated with provisioning of the related network service to the candidate server in response to the candidate server accepting provisioning of the related network service.

8. The method of claim 1, wherein the UDP probe is generated in response to a client UDP packet received from a client for accessing the requested network service.

9. The method of claim 8, further comprising:
inserting a SRv6 header into the client UDP packet to create a modified client UDP packet for the requested network service;
sending the modified client UDP packet for the requested network service within the network environment to the plurality of candidate servers for provisioning the requested network service;
assigning another candidate server of the plurality of candidate servers to provision the requested network service in response to the another candidate server accepting provisioning of the requested network service based on the modified client UDP packet, wherein the another candidate server is configured to gather one or more additional pre-fetched resources for provisioning the requested network service; and
steering, from the load balancer of the network environment, additional traffic associated with provisioning of the requested network service to the another candidate server for provisioning of requested network service using the one or more additional pre-fetched resources.

10. The method of claim 9, wherein the modified client UDP packet is passed sequentially along the plurality of candidate servers until the another candidate server accepts provisioning of the requested network service.

11. The method of claim 1, further comprising:
generating a temporal dependency mapping of network services provisioned through the network environment including the requested network service and the related network service; and
identifying the related network service is associated with the requested network service based on the temporal dependency mapping of the network services.

12. The method of claim 11, wherein the temporal dependency mapping is generated by;
analyzing traffic to generate per-flow information of traffic flows in the traffic;
translating the per-flow information into per-service information to identify a service-to-service delay distribution of the network services provisioned through the network environment; and
generating the temporal dependency mapping of the network services based on the service-to-service delay distribution of the network services.

13. The method of claim 12, wherein the per-flow information corresponds to an appearance of a traffic flow in the traffic and includes monitored flows within a time window including the traffic flow.

14. The method of claim 12, wherein two or more network services are found to be related if a corresponding service-to-service delay distribution of the two or more network services varies in the service-to-service delay distribution of the network services.

15. A system comprising:
one or more processors; and
at least one computer-readable storage medium having stored therein instructions which, when executed by the one or more processors, cause the one or more processors to perform operations comprising:
monitoring traffic in a network environment for providing access to network services through the network environment;
identifying a requested network service for a client;
identifying a related network service associated with the requested network service recognized by monitoring the traffic in the network environment, wherein the related network service is identified before the related network service is requested by the client;
sending a User Datagram Protocol (UDP) probe for the related network service within the network environment to at least one candidate server of a plurality of candidate servers for provisioning the related network service;
assigning a candidate server of the plurality of candidate servers to provision the related network service in response to the candidate server accepting provisioning of the related network service based on the UDP probe, wherein the candidate service is configured to gather, before the related network service is requested by the client, one or more pre-fetched resources for provisioning the related network service;
receiving a request for the related network service from the client either concurrently with provisioning of the requested network service or after the provisioning of the requested network service; and
steering, from a load balancer of the network environment, traffic associated with provisioning of the related network service to the candidate server for provisioning of the related network service.

16. The system of claim 15, wherein the candidate server is configured to provide the related network service using the one or more pre-fetched resources.

17. The system of claim 15, wherein the UDP probe is generated in response to a client UDP packet received from a client for accessing the requested network service and the instructions which, when executed by the one or more processors, further cause the one or more processors to perform operations comprising:
inserting a SRv6 header into the client UDP packet to create a modified client UDP packet for the requested network service;
sending the modified client UDP packet for the requested network service within the network environment to the plurality of candidate servers for provisioning the requested network service;
assigning another candidate server of the plurality of candidate servers to provision the requested network service in response to the another candidate server accepting provisioning of the requested network service based on the modified client UDP packet, wherein the another candidate server is configured to gather one or more additional pre-fetched resources for provisioning the requested network service; and
steering, from the load balancer of the network environment, additional traffic associated with provisioning of the requested network service to the another candidate server for provisioning of requested network service using the one or more additional pre-fetched resources.

18. The system of claim 15, wherein the instructions which, when executed by the one or more processors, further cause the one or more processors to perform operations comprising:
generating a temporal dependency mapping of network services provisioned through the network environment including the requested network service and the related network service; and
identifying the related network service is associated with the requested network service based on the temporal dependency mapping of the network services.

19. The system of claim 18, wherein the instructions which, when executed by the one or more processors, further cause the one or more processors to perform operations comprising:
analyzing traffic to generate per-flow information of traffic flows in the traffic;
translating the per-flow information into per-services information to identify a service-to-service delay distribution of the network services provisioned through the network environment; and
generating the temporal dependency mapping of the network services based on the service-to-service delay distribution of the network services.

20. A non-transitory computer-readable storage medium having stored therein instructions which, when executed by a processor, cause the processor to perform operations comprising:
monitoring traffic in a network environment for providing access to network services through the network environment;
identifying a requested network service for a client;
identifying a related network service associated with the requested network service recognized by monitoring the traffic in the network environment, wherein the related network service is identified before the related network service is requested by the client;
sending a User Datagram Protocol (UDP) probe for the related network service within the network environment to at least one candidate server of a plurality of candidate servers for provisioning the related network service, wherein the UDP probe includes an SRv6 header identifying the plurality of candidate servers;
assigning a candidate server of the plurality of candidate servers to provision the related network service in response to the candidate server accepting provisioning of the related network service based on the UDP probe, wherein the candidate server is configured to gather, before the related network service is requested by the client, one or more pre-fetched resources for provisioning the related network service;
receiving a request for the related network service from the client either concurrently with provisioning of the requested network service or after the provisioning of the requested network service; and
steering, from a load balancer of the network environment, traffic associated with provisioning of the related network service to the candidate server for provisioning of the related network service using the one or more pre-fetched resources.
